(19) United States
(12) Patent Application Publication
(10) Pub. No.: US 2006/0016634 A1
(43) Pub. Date: Jan. 26, 2006

(54) Handle-style loading control panel for bale wagons

(75) Inventors: Luke J. Harris, Leola, PA (US); Carl Douglas Quigley, Cedarville, CA (US); Frederic B. Thomson JR., Robesonia, PA (US); Stephen W. Jacobs, Lititz, PA (US); James L. Grubb, Denver, PA (US)

Correspondence Address: CNH AMERICA LLC, INTELLECTUAL PROPERTY LAW DEPARTMENT, PO BOX 1895, M.S. 641, NEW HOLLAND, PA, 17557, US

(73) Assignee: CNH America LLC, New Holland, PA (US)

(21) Appl. No.: 10/896,819

(22) Filed: Jul. 22, 2004

(51) Int. Cl. B60K 26/00

(52) U.S. Cl. 180/333

(57) ABSTRACT

The apparatus is a handle-style loading control panel for a bale wagon. The loading control panel is in a near vertical plane, supported adjacent to and above a conventional planar control panel, and ergonomically structured to permit the operator to rest a hand on the loading control panel and operate the loading control panel's controls with the thumb. The location of the loading control panel is adjustable but held stationary during use.

### BACKGROUND OF THE INVENTION

This invention deals generally with automatic bale wagons of the type adapted to pick up crop material bales in the field and automatically form stacks of these bales utilizing a variety of selected stacking patterns to form a stable, interlocked stack of bales.

Present day practices in crop harvesting involve the formation of bales of crop material such as hay or other crops into stacks for storage by using an automatic bale wagon. One type of bale wagon that has achieved wide spread commercial acceptance is the automatic bale wagon which uses three tables.

Such bale wagons include a first table which receives bales from a bale loader or pick up device mounted on the bale wagon. The first table accumulates a predetermined number of bales with the bales being arranged in a row in a pattern determined by a computer on board the bale wagon. A second table receives the rows of bales from the first table and accumulates several such rows. This group of rows is commonly referred to as a “tier”. A third table or load rack then receives the tiers from the second table and accumulates these tiers to form a “stack” on the load rack.

Once the stack has been accumulated on the load rack, it may be unloaded by pivoting the load rack 90 degrees and depositing the stack on the ground or other surface so that the first tier of bales which was accumulated on the second table is now the lowermost tier of the stack on the ground surface.

Although the stack arranging apparatus for such bale wagons is automatic, the loading and unloading functions of such wagons still requires many manual controls, because such functions vary with every load and must be coordinated with the position of the bale wagon. The loading and unloading controls have typically included two large control levers and an array of electrical switches. The control levers are directly linked to mechanical rods that operate hydraulic controls on the bale wagon, and the electrical switches control other functions.

The difficulty with such an arrangement is that the frequent push and pull movements of the levers lead to significant operator fatigue. Furthermore, the mechanical linkages required between the control levers and the mechanical operating rods limit the ability to isolate the operator cab from the vibration and noise of the bale wagon's operations.

It would be very beneficial to have a control system that not only reduces operator fatigue but also isolates the operator from the noise and vibration.

### SUMMARY OF THE INVENTION

The present invention completely eliminates the mechanical linkages between the control and operating system of a bale wagon and uses a completely electronic control system for the loading and unloading controls of bale wagons. Each of the new electronic controls is interconnected with a control circuit or computer that operates a solenoid valve within the bale loader's hydraulic system, and the solenoid valves operate hydraulic cylinders or motors that provide the necessary motion to perform the final task. This arrangement not only makes it possible to completely isolate the operator cab from mechanical vibrations caused by the previous mechanical linkages, but the location and layout of the controls are designed to minimize operator fatigue and allow the position of the controls to be adjusted for individual operator's preferences. Furthermore, the new controls are designed so that, although several electronic controls are added, they do not require any expansion of the operator cab's control panel and they are located at the operator's fingertips when the operator's arm is resting on the armrest of the operator's seat.

All this is accomplished by adding a handle-style loading control panel mounted on a support tube that protrudes out of the approximately horizontal surface of the conventional planar control panel. The loading control panel has two sections which are oriented an angle to each other, and each section has a surface facing the operator's position. In the preferred embodiment, one section is near horizontal and is located just above the conventional planar control panel. It is essentially a hand rest section upon which the palm of the operator's hand can be rested, and the other section, a control section, includes the loading and unloading pushbutton controls on its side surface. The pushbuttons can then be operated by the operator's thumb. Moreover, when the operator's hand is resting on the hand rest section, the controls on the surface of the conventional planar control panel are within easy reach of the fingers of that hand. Thus, the operator's arm does not have to move any significant distance or push against any force since the loading control panel itself does not move.

The loading control panel of the invention can also be repositioned to adjust to the operators reach, chair position, and posture. This adjustment is available in three directions. The first adjustment is axial along the support tube. The support tube of the loading control panel is actually constructed as an inside tube telescoping within a second slightly larger concentric outer tube. The outer tube has a circular clamp, similar to a pipe damp, at its top end. This clamp is tightened to hold the inner tube or loosened to permit raising or lowering the inner tube and the loading control panel attached to it. Furthermore, when the clamp atop the outer tube is loosened, the loading control panel can also be rotated to adjust its orientation relative to the operator's seat within the control cab and a user's hand. The use of hollow tubes for the support structure allows the wires interconnecting the loading control panel with the control circuitry to be held and protected within the tubes, and provides the means for the wires to penetrate the conventional planar control panel.

The support tube and loading control panel can also be pivoted forward away from the operator′ seat or back toward the operator's seat. This is accomplished in the preferred embodiment by attaching the bottom of the support tube to a slot within a vertical panel and clasping the upper part of the support tube with a tight fitting grommet as the tube passes through the conventional planar control panel. Thus, by loosening a thumbscrew passing through the bottom slot, the support tube and loading control panel can be pivoted forward and back at the tight fitting grommet as the thumbscrew slides within the slot.

An alternate arrangement for pivoting the support tube uses a ball joint on the existing control panel and lock screws on the ball joint. This apparatus furnishes an additional direction of motion for the adjustment by also allowing right and left adjustment along with forward and back.

Overall, the present invention provides a compact, ergonomically comfortable loading control panel that takes up very little space in a bale wagon control cab.

### BRIEF DESCRIPTION OF THE DRAWINGS

FIG. 1 is a side view of a conventional prior art bale wagon with a partially formed block of bales on its third table or load rack, and forming a tier of bales on its second, tier forming, table.

FIG. 2 is a side view of the loading control panel of the preferred embodiment of the invention.

FIG. 3 is a side view of the loading control panel and its support tube as they are installed in the cab of a bale wagon.

FIG. 4 is a side view of an alternate structure for adjusting the position of the loading control panel and the support tube by the use of a ball joint mounted on the conventional planar control panel.

### DETAILED DESCRIPTION OF THE INVENTION

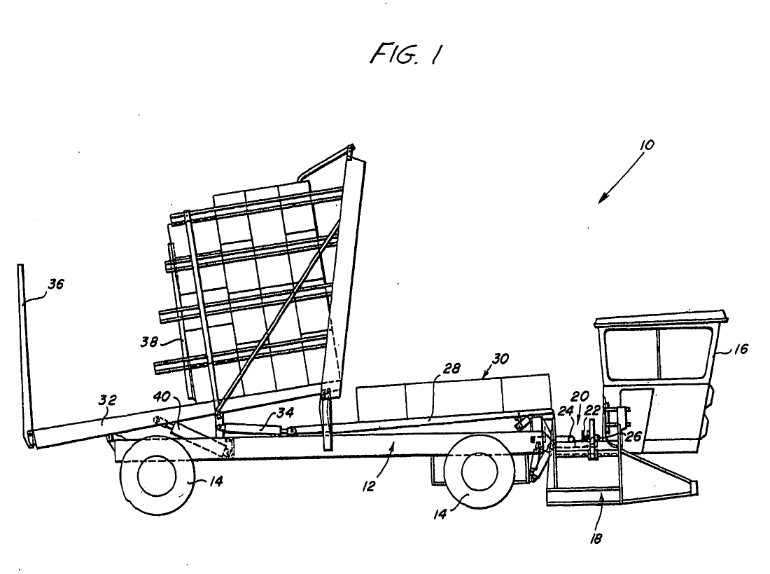

FIG. 1 is a side view of a conventional prior art bale wagon 10 with a partially formed stack of bales on its load rack 32, and forming a tier of bales on its second, tier forming, table 28. It is this type of bale wagon into which the loading control panel of the present invention is installed. The significance of the controls that will be described in regard to the present invention is best understood with reference to the operation of bale wagon 10.

Referring to FIG. 1, bale wagon 10 has mobile chassis 12 with wheels 14 and an operator cab 16. Cab 16 includes the various controls both for the operation of bale wagon 10 as a vehicle and for the operation of the various bale loading, unloading, and stacking operations of the machine.

Bale wagon 10 is provided with bale loader 18 adapted to pick bales up from the field and deposit them on first table 20. First table 20 is provided with cross conveyor 22 positioned between rails 24 and 26, so that the bales are dropped onto the first table 20 and are held by cross conveyor 22.

Cross conveyor 22 initially receives the bales and moves them toward the left side (the far side in FIG. 1) of the machine until a left side limit switch is actuated. Cross conveyor 22 then reverses and pulls the right-most bale until a right side limit switch is contacted and the conveyor is halted. In this way, the sides of the bales in the stack are aligned evenly on both sides of the stack, providing a more stable stack.

After the appropriate number of bales has been deposited on first table 20, first table 20 operates to deposit the bales onto second table 28. Depending upon the way in which first table rails 24 and 26 are actuated, the bales will be placed upon second table 28 in either the “on edge” or “flat” orientation. After a plurality of bales has been deposited on second table 28 so as to form a tier 30, second table 28 is operated to deposit tier 30 onto load rack 32. For this purpose, hydraulic cylinder 34 is used for raising table 28.

Load rack 32 has a plurality of support tines 36 at its rear end, and also has rolling rack 38 against which the various tiers of bales are deposited. As succeeding tiers are deposited onto load rack 32, rolling rack 38 is retracted a distance substantially equal to the thickness of a tier, thus providing the necessary space for newly added tier 30. After a complete stack has been formed on load rack 32, the operator of the bale wagon drives the wagon to the appropriate location for storage of the stack, and then actuates the appropriate control mechanism to extend hydraulic cylinder 40 causing load rack 32 to pivot approximately 90 degrees. Thereafter, pusher feet (not shown) are extended and the stack of bales is pushed off of support tines 36 and deposited on the ground. Load bed 32 is then returned to its position shown in FIG. 1, and a new cycle of operation begins. The present invention deals with the controls for operating the loading and unloading features of bale wagon 10 described above.

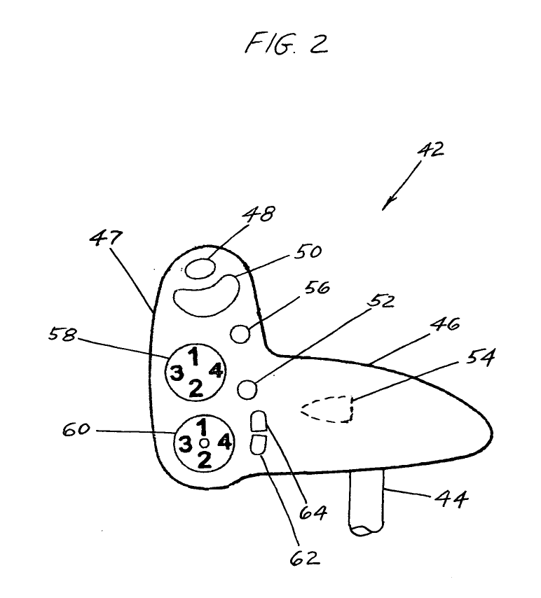

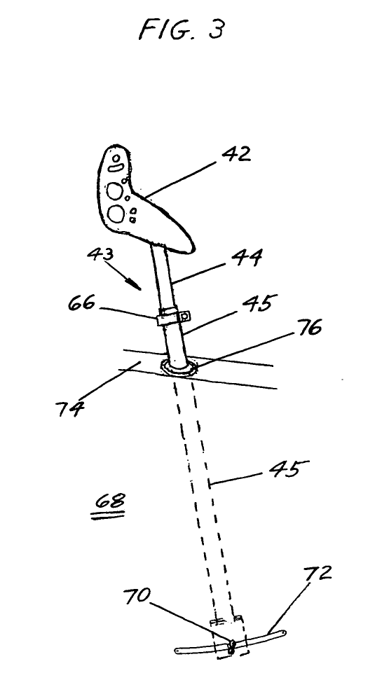

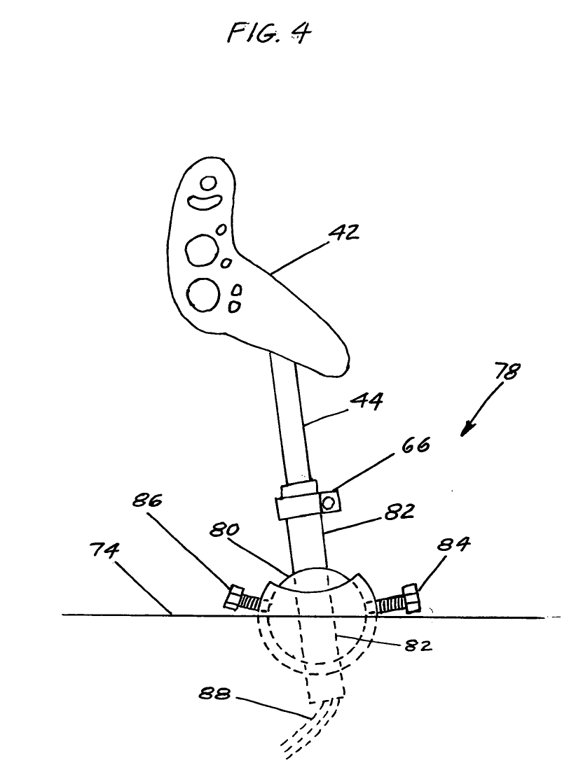

FIG. 2 is a side view of handle-style loading control panel 42 of the preferred embodiment of the invention mounted on support tube 44. Loading control panel 42 is a volume that has two sections, hand rest section 46 and control section 47, which are oriented an angle to each other. In the preferred embodiment the angle between the sections is typically 90 degrees, but the basic determination of the angle is that it must be such that one surface of control section 47 is accessible to the operator's thumb when the hand is on hand rest section 46. As shown in FIGS. 3 and 4, other angles are useable. Thumb operation of the controls also requires that at least one surface of each section, and particularly the surface with the control buttons, face the operator's position within the cab, and it is advantageous if control panel 42 is positioned in a vertical plane.

As shown in FIG. 2, in the preferred embodiment, hand rest section 46 is nearly horizontal and is located just above the conventional planar control panel. It's main function is as a hand rest upon which the palm or fingers of the operator's hand can be rested, while the other section, control section 47, includes the loading and unloading pushbutton controls on its surface facing the operator. The pushbuttons can then be operated by the operator's thumb. Moreover, when the operator's hand is resting on hand rest section 46, the controls on the surface of the conventional planar control panel are also within easy reach of that hand. Loading control panel 42 includes the several controls used for loading and unloading bale wagon 10. These controls are on control section 47 and are all pushbuttons that can be operated by the operator's thumb when the operator's hand is resting on hand rest section 46 and are described below.

Button 48 is the auto/manual button and is used to switch the stack pattern system between automatic and manual modes. The stack pattern system determines the pattern in which the bales are stacked, and each time button 48 is pushed, the system switches from the mode it is in to the other mode. The mode in which the bale wagon is operating is indicated on a display (not shown) on the conventional planar control panel in the cab.

Button 50 is the bale loader control. Pressing the left side of switch 50 lowers bale loader 18, and pressing the right side of switch 50 raises bale loader 18. Button 52 is the control that starts and stops the bail loader chain (not shown) that is located within bale loader 18. A second button 54 performs the same actions as button 52 and is located on the backside of hand rest section 46 so that it can be pushed by the operator's fingers. Button 56 controls cross conveyor 22 and is used to start and stop cross conveyor 22 when bale wagon 10 is in manual mode.

Buttons 52 and 54 are a significant change for the operator as they replace the need to push a lever with the action of pressing a switch. The prior art used a large lever to activate the bale loader chain that raises bales to the first table. Over the course of a work day the fore and aft movement of the lever required for each bale was very fatiguing to the operator. Replacing this arm motion with a simple button results in a more ergonomic action and reduces operator fatigue.

Switch 58 controls both tables 1 and 2. Pressing the top, labeled as 1, raises second table 28, and pressing the bottom, labeled as 2, lowers second table 28. Pressing the left side of switch 58, labeled 3, delivers bales from first table 20 to second table 28 in the “flat” condition. Pressing the right side of switch 58, labeled 4, delivers the bales to second table 28 “on edge”.

Switch 60 is the load rack and rolling rack control and is the most complex control on loading control panel 42 because it is actually a six position switch. Pressing the top of switch 60, labeled 1, raises load rack 32, and pressing the bottom of switch 60, labeled 2, lowers load rack 32. Each of these switch positions is itself a two part switch. Pressing either position part way provides a slow speed while pressing it fully provides a faster speed. The right and left sides of switch 60 control rolling rack 38. Pressing the left side, labeled 3, moves rolling rack 38 to the rear of load rack 32, while pressing the right side of switch 60, labeled 4, moves rolling rack 38 forward on load rack 32. Pressing positions 2 and 4 of switch 60 simultaneously brings rolling rack 38 forward while lowering load rack 32.

The remaining switches on loading control panel 42 are push-off feet switches 62 and 64. The push-off feet (not shown in FIG. 1) push the stack of bales off the rear of bale wagon 10 as the push-off feet are extended. Button 62 activates the extension of the push-off feet, and button 64 retracts the push-off feet.

FIG. 3 is a side view of loading control panel 42 and its support structure 43 as they are installed in the cab of a bale wagon to provide position adjustments for individual operators.

The adjustment of loading control panel 42 is available in three directions. The axial extension adjustment is available to move loading control panel 42 away from conventional planar control panel 74. This is easily accomplished in the preferred embodiment in which support tube 44 is an inside tube that can be slid within outer tube 45 that is slightly larger than and concentric with support tube 44. Outer tube 45 has circular clamp 66, similar to a pipe clamp, at its top end. Clamp 66 is tightened to hold support tube 44 in position or loosened to permit raising or lowering support tube 44 and loading control panel 42 attached to it. Also, when clamp 66 atop outer tube 45 is loosened, loading control panel 42 can be rotated to adjust its orientation relative to the operator's seat (not shown) within control cab 16.

In the preferred embodiment of the invention, loading control panel 42 can also be pivoted forward away from the operator's seat in control cab 16 or back toward the operator's seat. Thumbscrew 70 attaches the bottom of outer tube 45 to vertical panel 68 of the cab at slot 72 which is formed in vertical panel 68, and the upper region of the outer tube 45 passes through conventional planar control panel 74 with grommet 76 clasped tightly on outer tube 45. Thus, by loosening thumbscrew 70 within slot 72, outer tube 45, along with loading control panel 42 can be pivoted forward and back as thumbscrew 70 slides within slot 72 and outer tube 45 pivots within grommet 76.

It should be appreciated that support tube 44 and outer tube 45 are not part of the bale wagon control operation and do not move for that purpose. They are required to be stationary during operation of the bale wagon, and their only movements are for the purpose of ergonomically adjusting the position of loading control panel 42 for the operator. Furthermore, support tube 44 and outer tube 45 together form a conduit for the wires necessary to connect all the controls on loading control panel 42 to the control circuitry (not shown) of bale wagon 10, and support tube 44 and outer tube 45 also furnish a convenient and safe way for the wires to penetrate conventional planar control panel 74.

FIG. 4 is a side view of alternate support structure 78 for adjusting the position of loading control panel 42 by the use of ball joint 80 mounted on conventional planar control panel 74 and attached to short outer tube 82. Lock screws 84 and 86 on ball joint 80 are used to lock ball joint 80, outer tube 82, and loading control panel 42 into position after the desired adjustment. Alternate structure 78 furnishes an additional direction of motion for the adjustment of loading control panel 42 by using the full movement of ball joint 80 that also allows right and left adjustment along with forward and back. As with the apparatus shown in FIG. 3, ball joint 80 permits outer tube 82 to penetrate conventional control pattern 74 and serves as a conduit for control wires 88.

The present invention thereby provides a wide selection of additional electronic controls for loading and unloading a bale wagon, and does so without significant encroachment on the limited space in the operator cab. Furthermore the new controls are easily accessible and do not cause operator fatigue.

It is to be understood that the form of this invention as shown is merely a preferred embodiment. Various changes may be made in the function and arrangement of parts; equivalent means may be substituted for those illustrated and described; and certain features may be used independently from others without departing from the spirit and scope of the invention as defined in the following claims.

For example, loading control panel 42 can be used for other control functions and with more or fewer control buttons Moreover, additional controls can be located on the backside of loading control panel 42 along with or in place of button 54, and a different type of clamp can be used to hold support tube 44 within outer tube 45. Furthermore, an entirely different apparatus could be used to furnish the axial extension of support tube 44.

What is claimed as new and for which Letters patent of the United States are desired to be secured is:

1. A loading control panel within a control cab of a bale wagon that has a conventional planar control panel with the loading control panel comprising:
a control structure with a control section and a hand rest section attached to each other, with the sections oriented at an angle to each other, so that with an operator's hand on the hand rest section the operator's thumb can touch an operating surface of the control section;
at least two electronic controls for operating the loading and unloading operations of the bale wagon, with the electronic controls located on the operating surface of the control section; and
a stationary support structure attached to the control structure and to the control cab of the bale wagon and holding the control structure adjacent to and above the conventional planar control panel within the control cab.

2. The loading control panel of claim 1 wherein at least one electronic control is a button with different control functions dependent on how far down the button is pushed.

3. The loading control panel of claim 1 wherein the control structure is positioned in a vertical plane.

4. The loading control panel of claim 1 wherein the support structure is a tube.

5. The loading control panel of claim 1 wherein the support structure is a tube through which pass wires connecting the electronic controls on the loading control panel to control circuitry.

6. The loading control panel of claim 1 wherein the support structure is adjustable to vary the distance of the control structure above the conventional planar control panel.

7. The loading control panel of claim 1 wherein the support structure is an inner tube section sliding within an outer tube to vary the distance of the control structure above the conventional planar control panel, and the support structure includes a locking device to lock the position of the inner tube within the outer tube to prevent movement.

8. The control panel of claim 1 wherein the support structure is adjustable to vary the rotational orientation of the control structure relative to an operator's seat within the control cab.

9. The control panel of claim 1 wherein the support structure is an inner tube rotatable within an outer tube, and the support structure includes a locking device to lock the position of the inner tube within the outer tube to prevent rotation.

10. The loading control panel of claim 1 wherein the support structure is adjustable to vary the distance of the control structure from an operator's seat within the control cab.

11. The loading control panel of claim 1 wherein the support structure is adjustable to vary the distance of the control structure from an operator's seat within the control cab, and the distance adjustment is accomplished by pivoting the support structure at a location where the support structure penetrates the conventional planar control panel.

12. The loading control panel of claim 1 wherein the support structure is adjustable to vary the distance of the control structure from an operator's seat within the control cab, and the distance adjustment is accomplished by pivoting the support structure at a location where the support structure penetrates the conventional planar control panel and the support structure is lockable at a location below the conventional control panel to prevent pivoting.

13. The loading control panel of claim 1 wherein the support structure is adjustable to vary the distance of the control structure from an operator's seat within the control cab, and the distance adjustment is accomplished by pivoting the support structure at a grommet tightly clasping the support structure at the location where the support structure penetrates the conventional planar control panel.

14. The loading control panel of claim 1 wherein the support structure is adjustable to vary the distance of the control structure from an operator's seat within the control cab, and the distance adjustment is accomplished by pivoting the support structure with a lockable ball joint.

15. The loading control panel of claim 1 wherein the support structure penetrates the conventional planar control panel.

16. The loading control panel of claim 1 wherein the support structure penetrates the conventional planar control panel through a grommet tightly clasping the support structure.

17. The loading control panel of claim 1 wherein at least one electronic control is a button with different control functions at different locations on the button.
